(19) United States
(12) Patent Application Publication
(10) Pub. No.: US 2009/0315780 A1
(43) Pub. Date: Dec. 24, 2009

(54) INVERTED-F ANTENNA

(75) Inventors: Jia-Jiu Song, Jhonghe City (TW); Jr-Ren Jeng, Taipei City (TW); Mu-Kun Hsueh, Kaohsiung City (TW)

Correspondence Address: STEVENS & SHOWALTER LLP, 7019 CORPORATE WAY, DAYTON, OH, 45459-4238, US

(73) Assignee: SMARTANT TELECOM CO., LTD., Jhudong Township (TW)

(21) Appl. No.: 12/144,831

(22) Filed: Jun. 24, 2008

(51) Int. Cl. H01Q 9/04

(52) U.S. Cl. 343/700 MS

(57) ABSTRACT

An inverted-F antenna includes a radiation element, a ground element, a loop conductive pin, a signal feed-in portion, and a signal line. The antenna is designed as the signal feed-in portion and the ground portion sharing a single pin, thus solving the problem of the conventional inverted-F antenna having complicated components and increased cost due to using two independent components in parallel including a conductive pin and a signal feed-in portion for grounding and receiving feed-in signals.

### BACKGROUND OF THE INVENTION

1. Field of Invention

The present invention relates to an inverted-F antenna, in particular, to an inverted-F antenna with a signal feed-in point and a ground point sharing a single conductive pin.

2. Related Art

Wireless communication technology of using electromagnetic wave to transmit signals can achieve the effect of communicating remote devices without connecting materials, thus having a mobile advantage, so that the products utilizing the wireless communication technology are gradually increased, such as mobile phones, and notebook computers. Since the products utilize electromagnetic wave to transmit signals, antennae used for transmitting and receiving electromagnetic wave signals become necessary. The current antennae mainly include antennae exposed out of the device and build-in antennae. The antennae exposed out of the device may affect the volume and appearance of the products, and also be liable to be bent or broken due to the impact of the external force. Therefore, the build-in antennae become a trend.

Referring to FIG. 1, a schematic view of a conventional build-in antenna is shown. The antenna is an inverted-F antenna having a strip-shaped radiation element 1, a plate ground element 2 opposite to and spaced with the radiating antenna, and a conductive pin 3 and a signal feed-in portion 4 located between the strip-shaped radiation element 1 and the plate ground element 2. The conductive pin 3 connects one end of the radiation element 1 to the ground element 2, so as to serve as a ground pin. The signal feed-in portion 4 is disposed at a central position between the two ends of the radiation element 1, so as to receive the signals fed in from the signal line 5. When the signal feed-in portion 4 receives a signal current fed in from the signal line 5, the signal current is distributed to the left and right directions. Referring to FIG. 1, when the signal current flows directly from the signal feed-in portion 4 to the conductive pin 3, due to the opposite flowing directions of the signal current at the signal feed-in portion 4 and that at the conductive pin 3, the signal current at the left path may be counteracted to avoid resonating to generate the electromagnetic wave. The length L of the right path equals to the length of the right part of the signal feed-in portion 4 in the radiation element 1, that is approximately a quarter of the wavelength. Therefore, the electromagnetic wave having a specific frequency (f=c/λ) is emitted, the electromagnetic wave signal at this frequency is sensed, and the sensed signal current is transmitted to the signal line 5 through the signal feed-in portion 4 and then lead to the outside.

Since inverted-F antenna may only transmit and receive the electromagnetic wave at a single frequency, two independent conductive pin 3 and signal feed-in portion 4 are used for grounding and receiving the feed-in signal, which causes complicated components. Moreover, the strip-shaped pin disposed between the radiation element 1 and the ground element 2 fix the disposing position, and thus the input and output impedance is difficult to be adjusted as demanded.

Accordingly, the Patent Publication No. 00563274 has provided an antenna with a signal feed-in portion and a ground point sharing a single pin, so as to realize the simplification and solve the problems in the conventional art. Referring to FIG. 2, a conventional N-shaped conductive pin antenna 200 includes a radiation element 11, a ground element 12, a conductive pin 13, a signal feed-in portion 14, and a signal line 15. The conductive pin 13 is N-shaped, and has two ends connected to the radiation element 11 and the ground element 12 respectively. The signal feed-in portion 14 is located on the conductive pin 13 for connecting the signal line 15 and transmitting the signal current.

The conventional N-shaped conductive pin structure may indeed realize the simplification and solve the problems in the conventional art. However, in order to achieve multiple functions, the current 3C device is not only provided with a 3G wireless communication antenna, but also a Wi-Fi antenna, thereby achieving the wireless network connection. Nevertheless, when the 3C products tend to be small and delicate, the 3G antenna may be closer to the devices affecting each other such as the wireless network antenna. As a direct result, the 3G radiation efficiency is reduced, and the quality of the signal is affected.

### SUMMARY OF THE INVENTION

In view of the above problem, the present invention provides an inverted-F antenna. A design of loop conductive pin is used to replace the conventional design of two conductive pins.

The inverted-F antenna provided in the present invention includes a radiation element, a ground element, a loop conductive pin, a signal feed-in portion, and a signal line. The radiation element is used for resonating to transmit and receive two different frequencies f₁ and f₂. The ground element is a plate ground element opposite to and spaced with the radiating antenna. The loop conductive pin is located between the radiation element and the ground element, and assumes a loop structure in the center with two ends connected to the radiation element and the ground element respectively. The signal feed-in portion is connected to the loop structure, for connecting the signal line and transmitting a signal current.

In an inverted-F antenna disclosed in the present invention, the loop structure is used to improve the antenna radiation efficiency and increase the bandwidth of radiation. Being capable of replacing the conventional design of two conductive pins, the inverted-F antenna of the present invention may also have improved radiation efficiency at a low frequency compared with the design of N-shaped conductive pin when being close to the devices such as wireless network antenna.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional build-in antenna;

FIG. 2 is a schematic view of a conventional N-shaped conductive pin antenna;

FIG. 3 is a schematic view of a first embodiment of the present invention;

FIG. 4 is a schematic view of a second embodiment of the present invention;

FIG. 5A shows a low-frequency test result of the conventional N-shaped conductive pin antenna singly disposed below a panel;

FIG. 5B shows a high-frequency test result of the conventional N-shaped conductive pin antenna singly disposed below a panel;

FIG. 6A shows a low-frequency test result of the loop conductive pin antenna in the first embodiment of the present invention singly disposed below a panel;

FIG. 6B shows a high-frequency test result of the loop conductive pin antenna in the first embodiment of the present invention singly disposed below a panel;

FIG. 7 shows actual radiation efficiencies of the conventional N-shaped conductive pin antenna and the loop conductive pin antenna in the first embodiment of the present invention in FIGS. 5A, 5B, 6A, and 6B;

FIG. 8 is a curve diagram drawn according to the data in FIG. 7;

FIG. 9A shows a low-frequency test result of the conventional N-shaped conductive pin antenna close to a WiFi antenna (at a distance of 16 mm);

FIG. 9B shows a high-frequency test result of the conventional N-shaped conductive pin antenna close to the WiFi antenna (at a distance of 16 mm);

FIG. 10A shows a low-frequency test result of the loop conductive pin antenna in the first embodiment of the present invention close to the WiFi antenna (at a distance of 16 mm);

FIG. 10B shows a high-frequency test result of the loop conductive pin antenna in the first embodiment of the present invention close to the WiFi antenna (at a distance of 16 mm);

FIG. 11 shows actual radiation efficiencies of the conventional N-shaped conductive pin antenna and the loop conductive pin antenna in the first embodiment of the present invention in FIGS. 9A, 9B, 10A, and 10B;

FIG. 12 is a curve diagram drawn according to the data in FIG. 11;

FIG. 13A is a curve diagram drawn according to the actual radiation efficiencies of the conventional N-shaped conductive pin antenna in FIGS. 7 and 11; and

FIG. 13B is a curve diagram drawn according to the actual radiation efficiencies of the loop conductive pin antenna in the present invention in FIGS. 7 and 11.

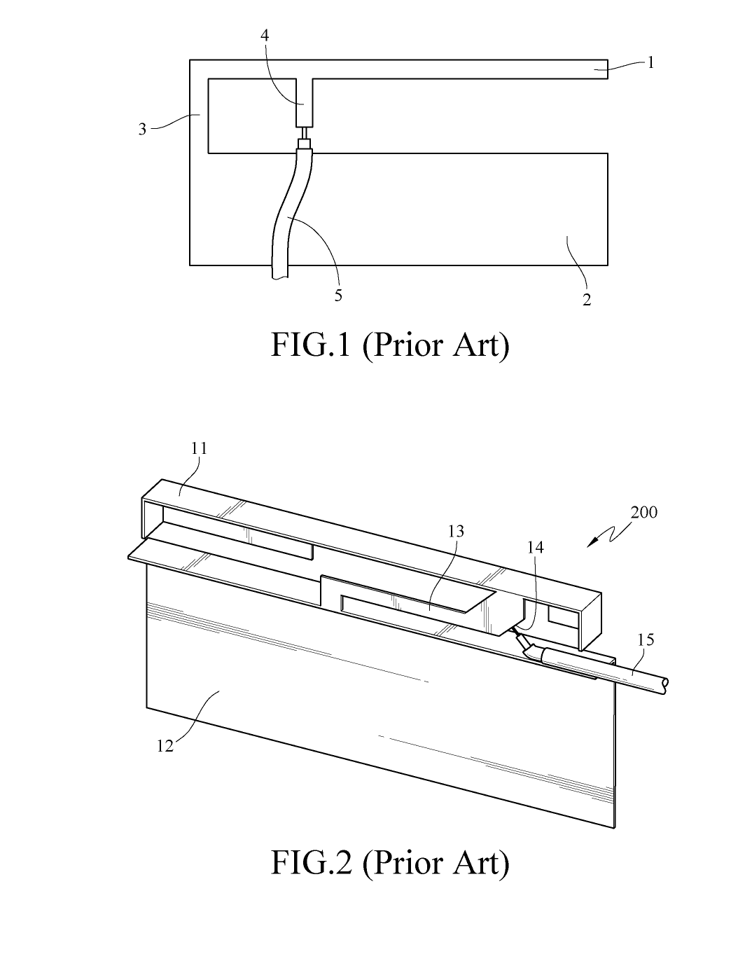

### DETAILED DESCRIPTION OF THE INVENTION

Features and implementations of the present invention are described herein below with accompanying drawings.

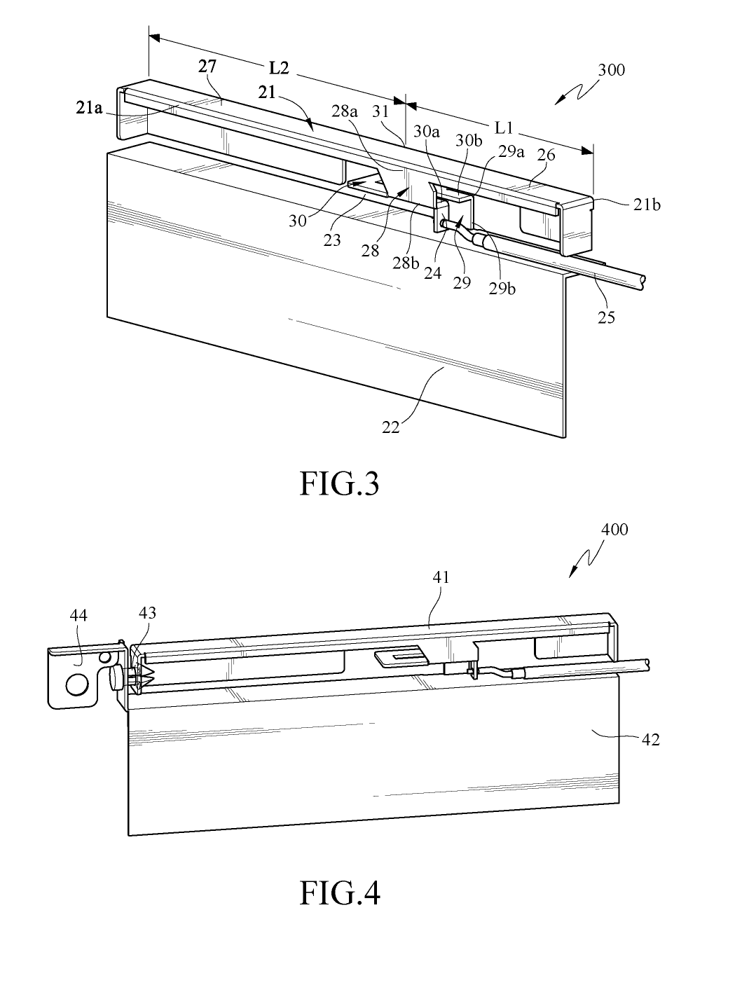

Referring to FIG. 3, a schematic view according to a first embodiment of the present invention is shown. The antenna 300 includes a radiation element 21, a ground element 22, a loop conductive pin 23, a signal feed-in portion 24, and a signal line 25.

The radiation element 21 is used for resonating to transmit and receive a first frequency f₁ and a second frequency f₂, and a length of the radiation element 21 depends on the wavelengths of the two different frequencies. The radiation element 21 is divided into a first section 26 resonating at the first frequency f₁ and a second section 27 resonating at the second frequency f₂. A length L₁ of the first section 26 approximately equals to a quarter of the wavelength λ₁ of the first frequency f₁, and a length L₂ of the second section 27 approximately equals to a quarter of wavelength λ₂ of the second frequency f₂. Therefore, the length L (L=L₁+L₂) of the radiation element 21 is a sum of a quarter of the wavelengths λ₁ and λ₂ of the two resonating frequencies f₁ and f₂.

The ground element 22 is a plate ground element opposite to and spaced with the radiating antenna. The size of the ground element 22 is relevant to the bandwidth of the antenna 300. In other words, the impedance and the bandwidth of the antenna 300 may change with the effective area of the ground element 22.

The loop conductive pin 23 is located between the radiation element 21 and the ground element 22, and has a first support arm 28, a second support arm 29, and a loop structure 30. The first support arm 28 has a first end 28a connected to a joint 31 of two sections 26 and 27 at a first side 21a of the radiation element 21, a second end 28b extending to the ground element 22 along the radiation element 21 without contacting the ground element 22. The second support arm 29 has a first end 29a connected to the ground element 22, and a second end 29b extending to a second side 21b of the radiation element 21 along the ground element 22 without contacting the radiation element 21. The loop structure 30 vertically bridges the first support arm 28 and the second support arm 29, and has a first end 30a connected to the second end 28b of the first support arm 28 not connected to the radiation element 21, and a second end 30b connected to the second end 29b of the second support arm 29 not connected to the ground element 22. The loop structure may be U-shaped, horseshoe-shaped, or of other loop shapes. In this embodiment, the first support arm 28 and the second support arm 29 are respectively perpendicular to the radiation element 21 and the ground element 22, and are parallel to each other. The two ends 30a and 30b of the loop structure 30 are vertically connected to the first support arm 28 and the second support arm 29 respectively.

The signal feed-in portion 24 is connected to the first end 30a of the loop structure 30 of the loop conductive pin 23, so as to connect the signal line 25. A signal current is transmitted or received to the loop conductive pin 23 and the signal line 25 through the signal feed-in portion 24.

When a signal is emitted, the signal current is transmitted from the signal line 25 to the loop conductive pin 23 through the signal feed-in portion 24, and distributed to the first support arm 28 and the loop structure 30. The signal current flowing to the first support arm 28 is directly fed into the radiation element 21 through the joint 31. Then, the signal current is resonated to radiate an electromagnetic wave signal through the radiation element 21. Likewise, when the radiation element 21 senses the electromagnetic wave to generate a signal current, the signal current is transmitted to the first support arm 28 through the joint 31. At this point, most of the signal current is directly fed into the signal feed-in portion 24 through the first support arm 28, and transmitted to the outside through the signal line 25.

The loop conductive pin 23 is used to prevent resonating to transmit the electromagnetic wave due to the different flowing directions of the current signal at two ends of the loop structure 30 when the signal current flows at the loop structure 30, so as to reduce the interference on the radiation element 21. Moreover, grooves at the center of the loop structure have a current coupling effect to increase the radiation bandwidth. Referring to FIG. 4, a schematic view according to a second embodiment of the present invention is shown. The difference between the structure of the device in the second embodiment and that in the first embodiment lies in that a structure 44 for fixing low-frequency radiation end is fabricated at a low-frequency radiation end 43 on a ground element 42 close to a radiation element 41. By means of a separating column made of non-conductive material, the low-frequency radiation end 43 and the structure 44 for fixing low-frequency radiation end are fixed. Therefore, when a antenna 400 is operated at a low frequency, the distance between the low-frequency radiation end 43 and a ground element 42 is fixed, so as to prevent the radiation element 41 close to the low-frequency radiation end 43 from contacting the ground element 42.

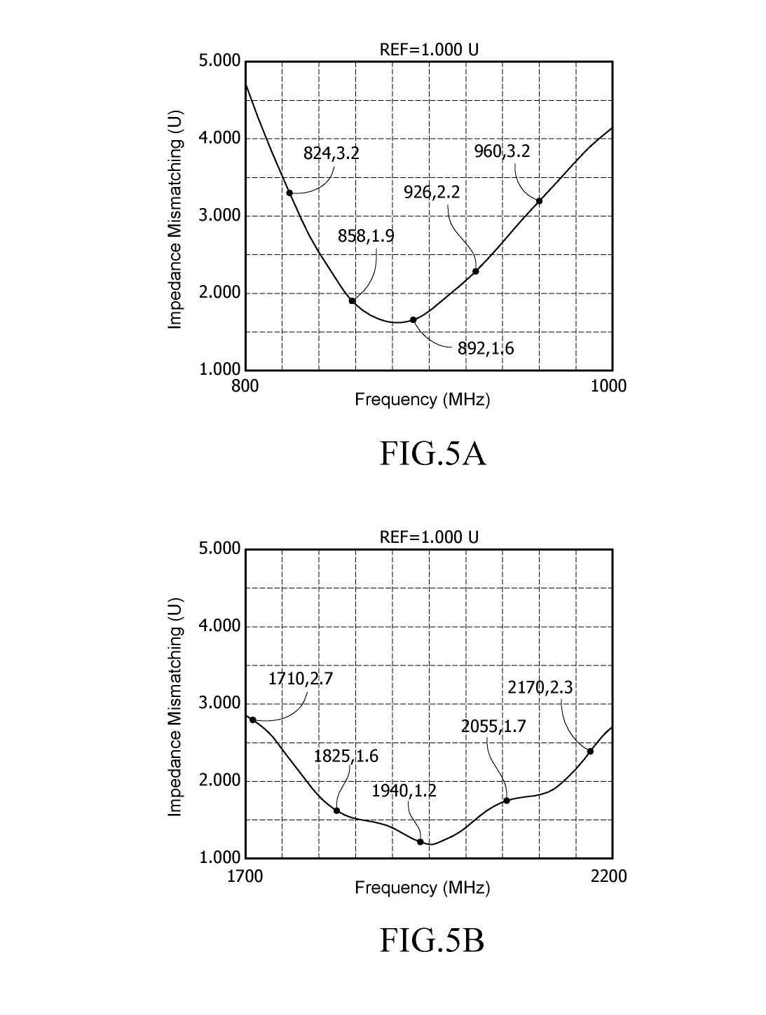

FIGS. 5A and 5B show test results of the conventional N-shaped conductive pin antenna singly disposed below a panel, which are standing wave rates (SWR) respectively measured at a low frequency (824 MHz-960 MHz) and at a high frequency (1710 MHz-2170 MHz).

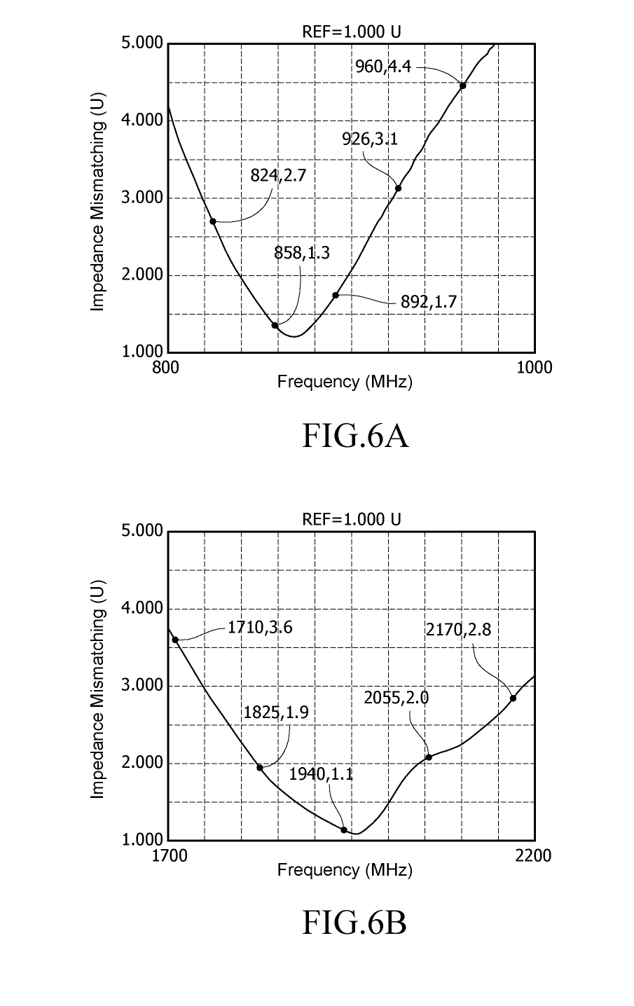

FIGS. 6A and 6B show test results of the loop ground antenna in the first embodiment of the present invention disposed below a panel, which are SWRs respectively measured at a low frequency (824 MHz-960 MHz) and at a high frequency (1710 MHz-2170 MHz).

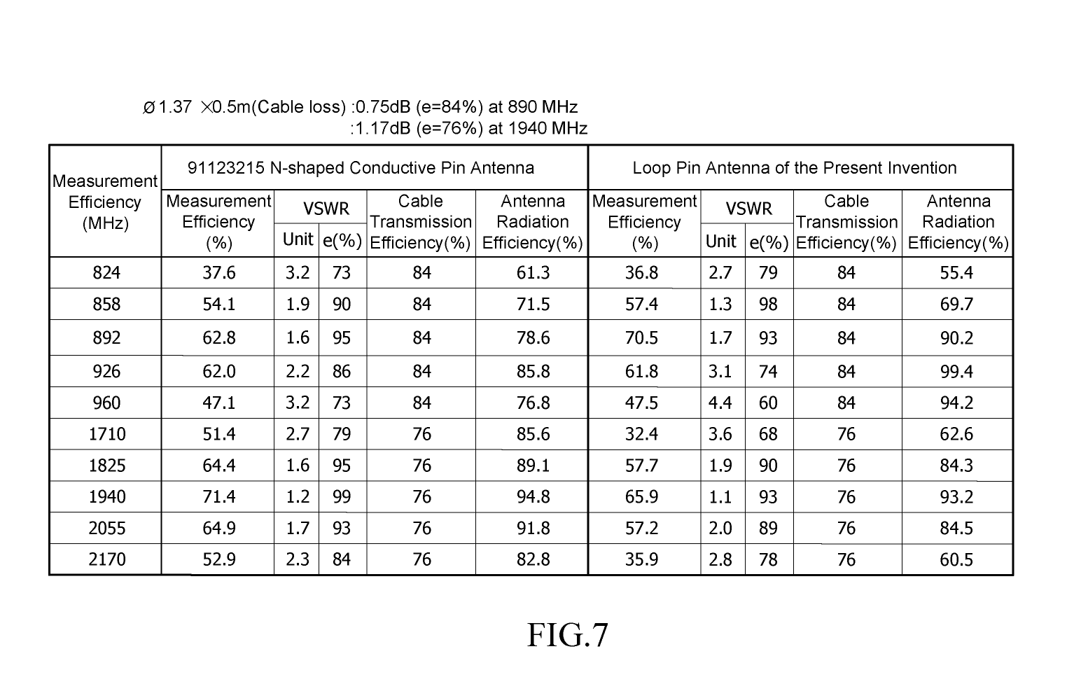

FIG. 7 shows actual radiation efficiencies of the conventional N-shaped conductive pin antenna and the loop conductive pin antenna in the first embodiment of the present invention in FIGS. 5A, 5B, 6A, and 6B (

$${e}_{antenna} = \frac{{e}_{test}}{{e}_{VSWR} \times {e}_{cable}} \text{:}$$

antenna radiation efficiency)(eₜₑₛₜ: measurement efficiency) (e_{VSWR}=1−[Γ]²:impedance mismatching efficiency, where

$$Γ = \frac{( VSWR - 1 )}{( VSWR + 1 ) )} ( {e}_{cable} = {10}^{( \frac{- Cable loss}{10} )} \text{:}$$

cable transmission efficiency).

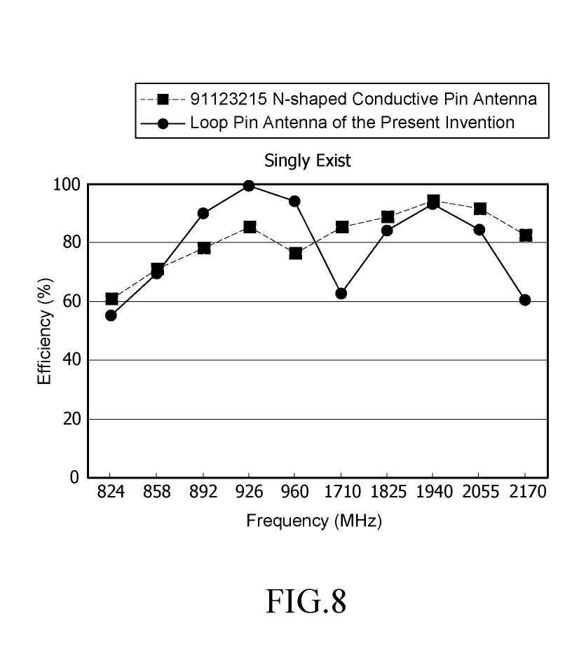

FIG. 8 is a curve diagram drawn according to the data of actual radiation efficiencies of the conventional N-shaped conductive pin antenna and the loop conductive pin antenna in the first embodiment of the present invention in FIG. 7. It can be known from FIG. 8 that, the loop conductive pin antenna in the present invention is more advantageous than the conventional N-shaped conductive pin antenna in better antenna radiation efficiency at the low frequency.

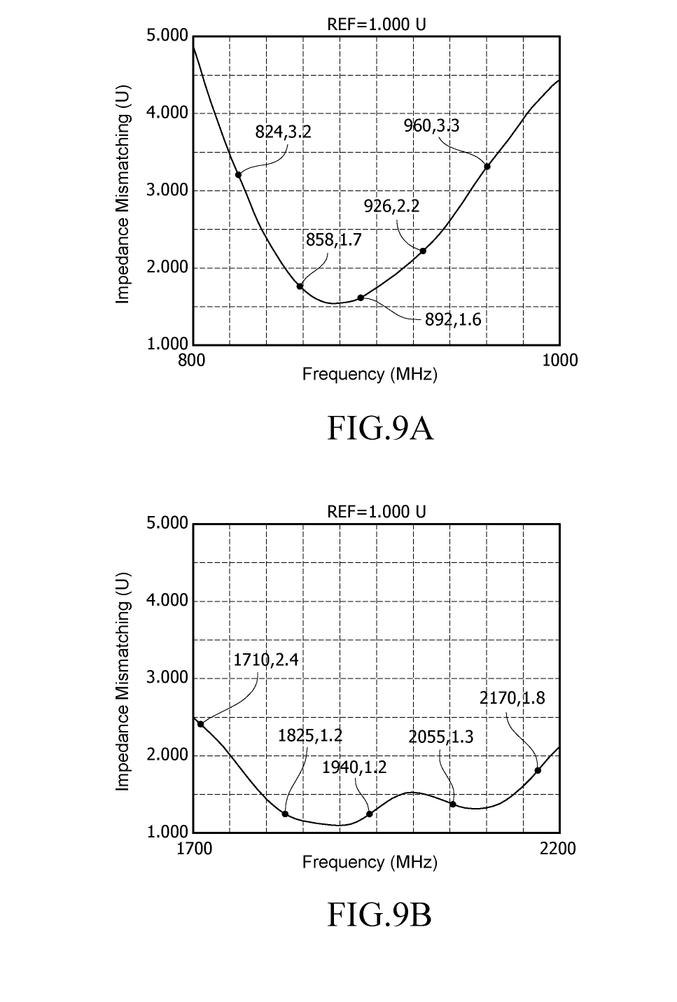

FIGS. 9A and 9B show test results of the conventional dual-frequency antenna close to a wireless network antenna (at a distance of 16 mm), which are SWRs respectively measured at a low frequency (824 MHz-960 MHz) and at a high frequency (1710 MHz-2170 MHz).

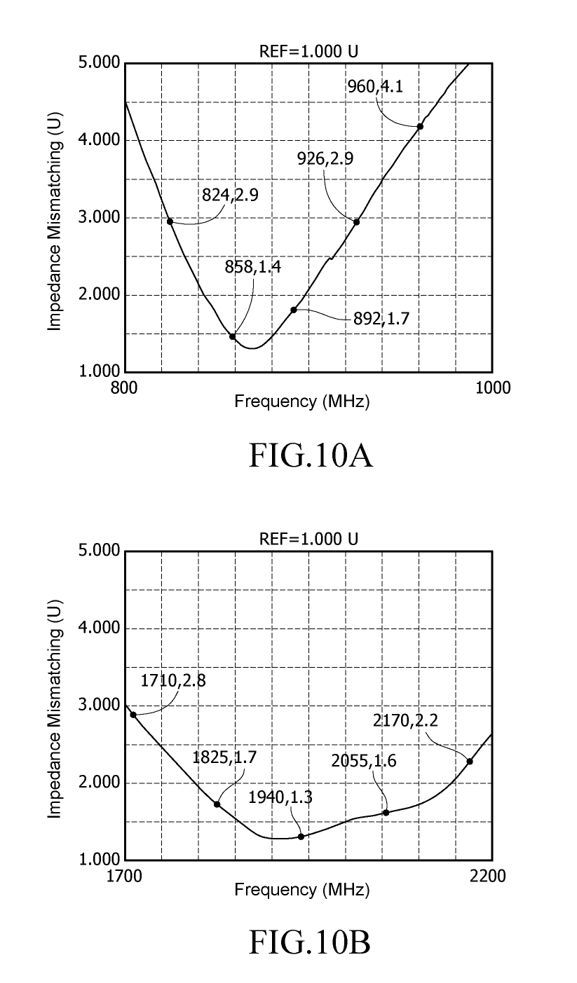

FIGS. 10A and 10B show test results of the loop conductive pin antenna in the first embodiment of the present invention close to the wireless network antenna (at a distance of 16 mm), which are SWRs respectively measured at a low frequency (824 MHz-960 MHz) and at a high frequency (1710 MHz-2170 MHz).

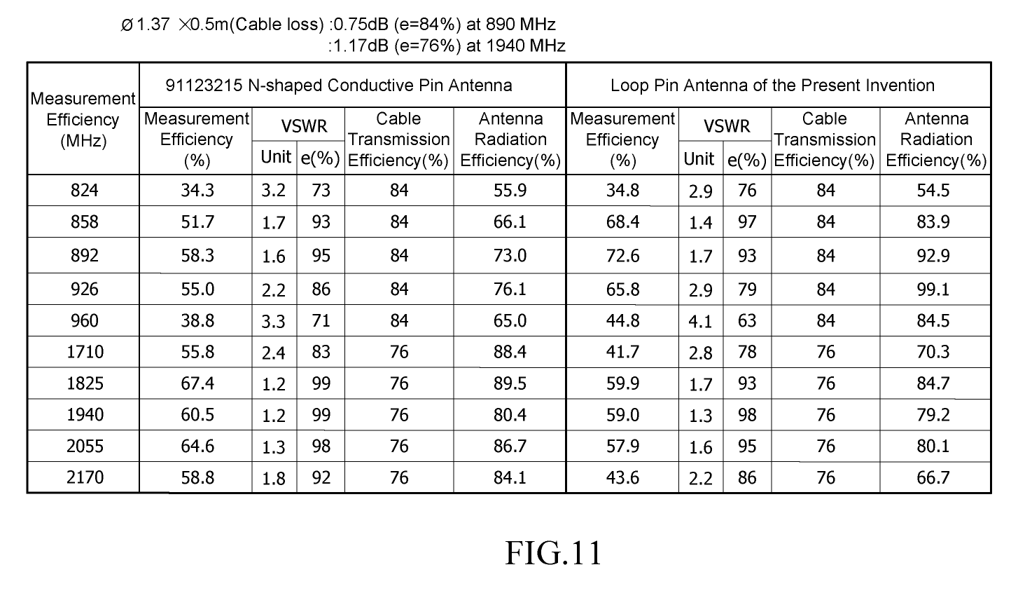

FIG. 11 shows actual radiation efficiencies of the conventional N-shaped conductive pin antenna and the loop conductive pin antenna in the first embodiment of the present invention in FIGS. 9 and 10.

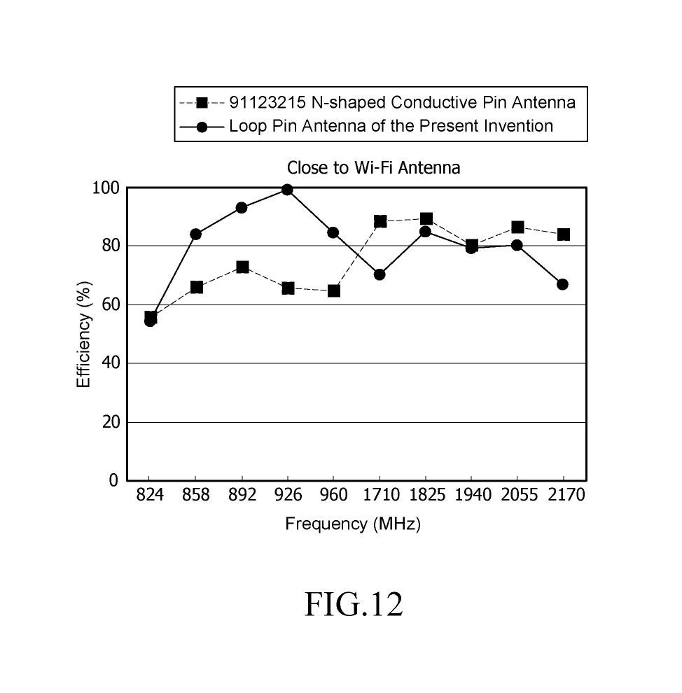

FIG. 12 is a curve diagram drawn according to the data of actual radiation efficiencies of the conventional N-shaped conductive pin antenna and the loop conductive pin antenna in the first embodiment of the present invention in FIG. 11. It can be known from FIG. 12 that, the loop conductive pin antenna in the present invention is more advantageous than the conventional N-shaped conductive pin antenna in obviously improved antenna radiation efficiency at the low-frequency portion close to the wireless network antenna.

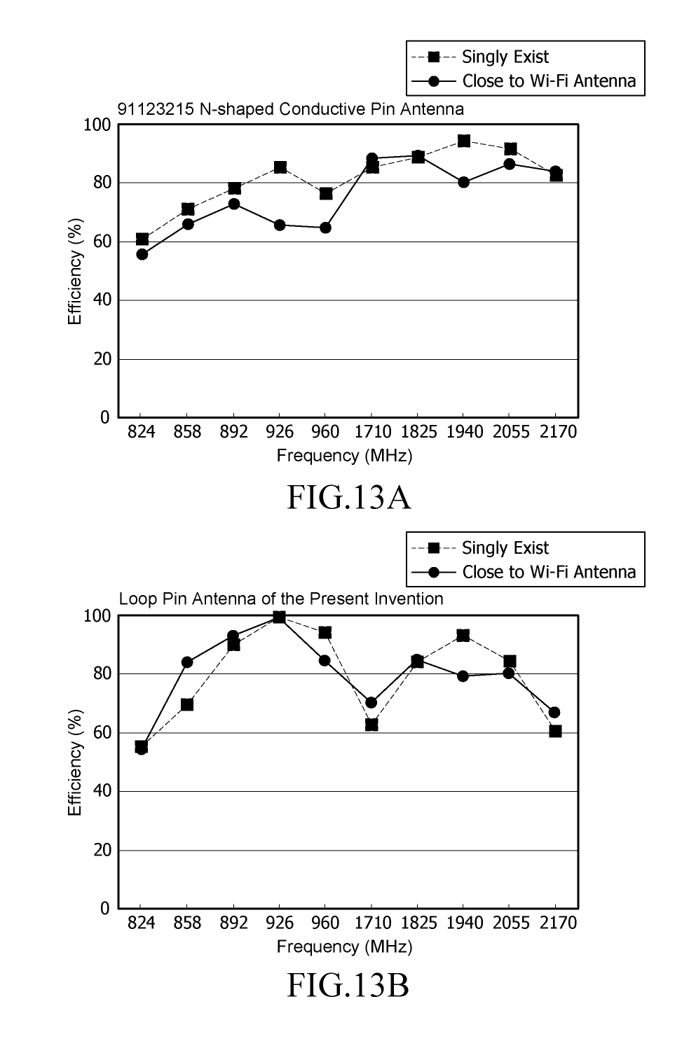

FIGS. 13A and 13B are curve diagrams drawn according to the actual radiation efficiencies of the conventional N-shaped conductive pin antenna and the loop conductive pin antenna in the first embodiment of the present invention in FIGS. 7 and 11. FIG. 13 shows, respectively at the upper and lower parts, the antenna radiation efficiencies of the conventional N-shaped conductive pin antenna and the loop conductive pin antenna in the first embodiment of the present invention singly disposed below the panel and close to the wireless network antenna. It can be known from FIGS. 13A and 13B that, the antenna radiation efficiency of the conventional N-shaped conductive pin antenna close to the wireless network antenna is obviously lower than the antenna radiation efficiency of the singly disposed antenna. Moreover, the loop conductive pin design of the present invention makes no obvious difference when being close to the wireless network antenna.

What is claimed is:

1. An inverted-F antenna, comprising:
a radiation element, having a first side and a second side opposite to each other for resonating to transmit and receive corresponding frequencies;
a ground element, opposite to and spaced with the radiation element
a loop conductive pin, located between the radiation element and the ground element, assuming a loop structure in the center, and having two ends connected to the radiation element and the ground element respectively; and
a signal feed-in portion, connected to the loop structure, for feeding a signal current into the loop structure and receiving a signal current fed in by the loop structure.

2. The inverted-F antenna according to claim 1, wherein the radiation element is used for resonating to transmit and receive a first frequency and a second frequency.

3. The inverted-F antenna according to claim 2, wherein a length L of the radiation element is a sum of a quarter of wavelengths of the first frequency and the second frequency.

4. The inverted-F antenna according to claim 1, wherein the ground element is a plate structure.

5. The inverted-F antenna according to claim 1, wherein the loop conductive pin comprises a first support arm, a second support arm, and the loop structure, the first support arm has one end connected to the radiation element, and the other end extending to the ground element and connected to one end of the loop structure; the second support arm has one end connected to the ground element, and the other end extending to the radiation element and connected to the other end of the loop structure.

6. The inverted-F antenna according to claim 5, wherein the first support arm and the second support arm are perpendicular to the radiation element and the ground element respectively, and are parallel to each other.

7. The inverted-F antenna according to claim 5, wherein the loop structure vertically bridges the first support arm and the second support arm.

8. The inverted-F antenna according to claim 5, wherein the loop structure has one end connected to the first support arm, and the other end connected to the second support arm.

9. The inverted-F antenna according to claim 1, wherein the loop structure is “U”-shaped or horseshoe-shaped.

10. The inverted-F antenna according to claim 1, wherein the signal feed-in portion is connected to one end of the loop structure.

11. The inverted-F antenna according to claim 1, wherein a low-frequency radiation end on the ground element close to the radiation element is vertically connected to a structure for fixing low-frequency radiation end.

12. The inverted-F antenna according to claim 11, wherein a non-conductive element is used in the structure for fixing low-frequency radiation end to connect the low-frequency radiation end of the radiation element and the structure for fixing low-frequency radiation end.

13. The inverted-F antenna according to claim 12, wherein the non-conductive element is a screw.
